(19) United States
(12) Patent Application Publication
(10) Pub. No.: US 2026/0081047 A1
(43) Pub. Date: Mar. 19, 2026

(54) RADIATION PROTECTION HOUSING

(71) Applicant: FRAUNHOFER-GESELLSCHAFT ZUR FOERDERUNG DER ANGEWANDTEN FORSCHUNG E.V., Muenchen (DE)

(72) Inventors: Michael SALAMON, Erlangen (DE); Johannes LEISNER

(21) Appl. No.: 19/397,129

(22) Filed: Nov. 21, 2025

Related U.S. Application Data
(63) Continuation of application No. PCT/EP2023/063651, filed on May 22, 2023.

(51) Int. Cl. G21F 3/00

(52) U.S. Cl. CPC G21F 3/00

(57) ABSTRACT

Radiation protection housing comprising: a base frame; a plurality of shielding panels fastened to the base frame by means of releasable fastening devices; wherein the base frame, the shielding panels and the releasable fastening devices are part of a modular construction kit system.

### CROSS-REFERENCE TO RELATED APPLICATION

This application is a continuation of copending International Application No. PCT/EP2023/063651, filed May 22, 2023, which is incorporated herein by reference in its entirety.

Embodiments of the present invention relate to a radiation protection housing, in particular a radiation protection housing based on a modular construction kit concept.

### BACKGROUND OF THE INVENTION

Radiation protection housings for X-ray systems represent a market access restriction for new providers of X-ray testing technology. The design of the required shielding, the appropriate construction of a housing and its production require a number of competencies with a high degree of specialization. Even cohesive process steps such as the design of the lead thickness and the appropriate production are usually not available from one provider alone. Accordingly, the costs for the realization of suitable housings are very high and the availability and delivery time are very limited. At the same time, the reliability of a radiation protection housing is of great importance, since the threat to life or physical condition caused by insufficient shielding is high and the suitability therefore has to be checked by an independent expert in a 5-year cycle. This requires a robust system concept which comprises as few weak points as possible in terms of shielding and longevity, since the manufacturer has to carry out complex rework otherwise.

This therefore means that current radiation protection housings are essentially custom-made item which include semi-finished products, such as lead in the form of profiles, cuts, rolls, building blocks, film or lead wool. A supplier of lead plates is Schneider. There are also companies which develop custom-built radiation protection cabins, such as Ludwig Michl GmbH or Roehr+Stolberg.

In patent literature, there are also some approaches as to how a radiation protection shield is to be constructed. One example is disclosed in CN 108472005 B. U.S. Pat. No. 5,334,847 A, EP 0220937 A2, WO 2009121907 A1 and EP 2501293 B1 also belong to the conventional technology. All approaches known from the patent literature have in common that they comprise a high degree of specialization for corresponding applications. Furthermore, reference is also made to DIN 54113, which defines fundamental principles for the construction of such housings.

### SUMMARY

An embodiment may have a radiation protection housing comprising: a base frame; a plurality of shielding panels fastened to the base frame by means of releasable fastening devices or by means of releasable fastening devices with a radiation protection function; wherein the base frame, the shielding panels and the releasable fastening devices are part of a modular construction kit system; wherein the plurality of shielding panels are shielding panels of different geometries, wherein the first geometry comprises 4 folded edges, the second geometry comprises 2 folded edges, and the third geometry comprises no folded edge.

Another embodiment may have a radiation protection housing comprising: a base frame; a plurality of shielding panels fastened to the base frame by means of releasable fastening devices or by means of releasable fastening devices with a radiation protection function; wherein the base frame, the shielding panels and the releasable fastening devices are part of a modular construction kit system; wherein the plurality of shielding panels are shielding panels of different geometries, wherein the geometries differ by the number of folded edges. Embodiments of the present invention provide a radiation protection housing based on the principle of a construction kit. The radiation protection housing includes a base frame and a plurality of shielding panels fastened to the base frame by means of releasable fastening devices (or fastening means). The base frame, shielding panels and releasable fastening devices are part of a modular construction kit. For example, the base frame may be constructed analogously to the known panel profiles. According to embodiments, the shielding panels are designed to shield or absorb radiation, in particular X-ray radiation and in this case in particular X-ray radiation with, for example, 60 kV, 130 kV or 160 kV. According to further embodiments, the construction kit includes a plurality of shielding panels, e.g., with different thicknesses, so that different shielding properties or generally different shielding properties and different lateral dimensions are created. For example, there may be a predefined grid inherent to the construction kit, so that the different shielding panels have different sizes. According to the same grid, the base frame may also have different dimensions. Advantageously, as already mentioned above, a profile, e.g. an aluminum profile, on which the shielding panels are mounted, is used for the base frame. According to embodiments, a radiation protection profile or profile with a radiation protection element may be provided, in particular a radiation protection element arranged along a side face of the profile and/or an end face of the housing. Thus, the aluminum profile frame may advantageously be configured such that the corners and edges could also be realized without overlapping panels.

According to embodiments, mounting is done by fastening devices. According to embodiments, these have a shielding collar. That is, viewed from the other side, the modular construction kit includes a shielding collar for the fastening devices.

Embodiments of the present invention are based on the finding that, due to the modular construction of base frames (of different size) and shielding panels (of different shielding class and/or size) in conjunction with releasable fastening devices, a modular construction kit system by means of which radiation protection housings may be produced in a simple manner may be provided. This results in the following advantages:

Embodiments greatly simplify market access for new market participants in the X-ray market. Embodiments offer a high potential for savings, since the design and production costs are minimized by relying on mass components that are simple to produce. Furthermore, embodiments close an important gap between a greatly diversifying X-ray component market and the growing demand for integrated X-ray systems.

According to embodiments, all components, such as the shielding panels, fastening devices and the base frame, are configured such that sufficient shielding corresponding to the desired shielding class is created at the transition points. For this purpose, according to embodiments, the fastening devices maybe combined with a shielding collar, e.g., having the shape of a washer or the shape of a cover for a screw head. Like the shielding panels, the shielding collar comprises a shielding material, so that no radiation can penetrate here. According to embodiments, the geometry of the shielding panels is also adapted, so that they also prevent radiation emergence at the transition points, e.g. the edges. Such a modular construction kit system advantageously provides a scalable radiation protection housing which, depending on the choice of components from the construction kit, is suitable for different shielding classes. As a result, the radiation protection housing can be used more flexibly, variably and at the same time cost-efficiently, since a special configuration of the respective housing is not necessary, but rather the components of the construction kit system themselves are dimensioned and specified.

At this point, it is to be noted that not only the shielding panels, as mentioned above, but also all other further parts of the modular construction kit system, e.g. the shielding collars, may comprise corresponding shielding properties. According to embodiments, the shielding panels, shielding collars and further parts may be specified corresponding to a specific shielding class. For example, differences may result from the choice of material or the material thickness, so that the components of the same type therefore have different shielding characteristics, e.g. corresponding to the radiation protection class 60 kV, 130 kV or 160 kV. Of course, other radiation protection classes are also conceivable. In this case, a fixed categorization may be used. In order to facilitate the application, a color identification of the corresponding elements may be carried out corresponding to the categorization.

With regard to the shielding panels, it is to be noted that, according to embodiments, these may comprise a sandwich construction, i.e. a central element, e.g. a lead element with enveloping metal sheets, is provided. According to embodiments, the shielding panels may have a different geometry. For example, the geometry may differ by the number of folded edges, so that, e.g., a first geometry comprises four folded edges, a second geometry comprises two folded edges, and a third geometry comprises no folded edge. As a result, an overlap can be created in the edge region, so that an exit of radiation in the edge region is advantageously excluded. However, the overlap is limited to one layer, in order to precisely define the construction height here. Due to the fact that a sheet with four folded edges, a sheet with two folded edges, and a sheet without a folded edge are provided in the modular construction kit, the single-layer overlap is ensured not only in the edge region, but also at the corners.

According to further embodiments, the modular modular construction kit comprises screw-on plates for the outside, so that elements can be fastened to the outside of the radiation protection housing, or the radiation protection housing can be connected to elements. A mounting point may also be provided for the inside. This is advantageously arranged in the base frame. In this case, it is also conceivable that elements in the interior, such as an X-ray detector in the X-ray tube, may be connected to the housing. According to further embodiments, a screw-on plate may also be provided for mounting an element in the radiation protection housing, or the radiation protection housing may be provided on an element on the outside, depending on how the screw-on plate is mounted. According to embodiments, the screw-on plate replaces a shielding panel, for example, and therefore also comprises a shielding material according to further embodiments.

According to further embodiments, further attachments, such as a cable bushing, a door and a flap, may also be provided. Advantageously, these parts are configured as a penetration of the radiation protection housing and may be provided, for example, on an opening of a shielding panel. According to embodiments, the attachments are mounted into the shielding panel from the inside of the radiation protection housing, wherein the attachments have such a geometry that there is also an overlap with the shielding panel, in order to prevent radiation leakage.

According to embodiments, the radiation protection housing is configured as a cubic shape, so that the shielding panels have a rectangular shape, for example. According to embodiments, the radiation protection housing has a size of 0.5 to 5 m³ or between 0.8 and 1.5 m³. A typical size is, for example, 1×1×1 m³.

### BRIEF DESCRIPTION OF THE DRAWINGS

Embodiments of the present invention will be detailed subsequently referring to the appended drawings, in which:

FIG. 1 shows a schematic illustration of a basic structure of a profile system for use as a base frame according to embodiments;

FIG. 2a, b show schematic illustrations of a shielding collar in a side sectional illustration and a view according to embodiments;

FIG. 3 shows a schematic illustration of shielding panels according to embodiments;

FIG. 4 shows a schematic illustration of a screw-on situation for an attachment according to embodiments;

FIG. 5a, b show schematic illustrations of a screw-on plate for a radiation protection housing in a sectional illustration and a top view according to embodiments;

FIGS. 6a, b show schematic illustrations of the screw-on plate in a mounted state

according to embodiments;

FIG. 7 show a schematic illustration of a fully mounted radiation protection housing including optional components according to embodiments; and

FIG. 8 show a schematic illustration of a profile for the frame with a radiation protection element according to embodiments.

### DETAILED DESCRIPTION OF THE INVENTION

Before embodiments of the present invention will be explained in the following with reference to the accompanying drawings, it should be pointed out that elements and structures having the same effect are provided with the same reference numerals, so that the description thereof may be applied to one another or may be exchanged.

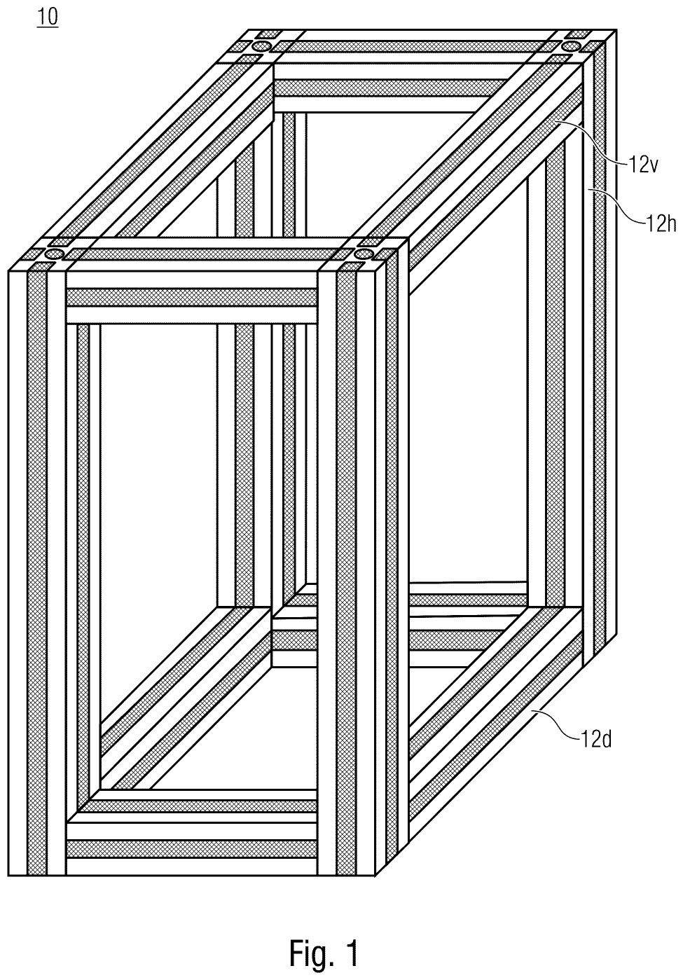

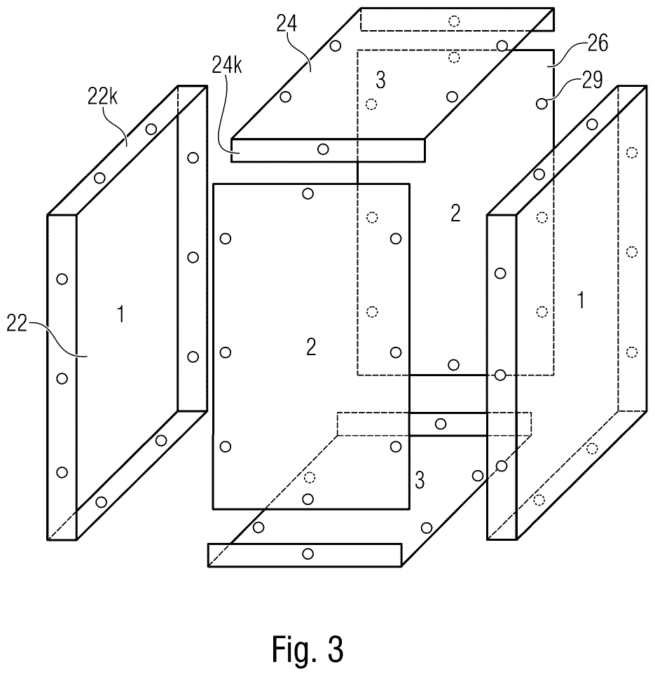

FIGS. 1, 2, 3 illustrate the basic components of a radiation protection housing which is based on a modular construction kit concept. The idea of the modular construction kit for manufacturing a radiation protection housing is that individual components, such as shielding panels, frames or frame components and fastening devices, are coordinated with one another such that the compatibility between them is ensured and a clearly defined radiation protection property and dimensioning is achieved independently of the assembly of the components. All elements illustrated in the following, in particular the base frame illustrated in FIG. 1 and the shielding panels illustrated in FIG. 3, may have different sizes. A typical size is 1×1×1 m, resulting in a cubical of 1 m³. Overall, the cubical may, of course, also be smaller, such as 0.25 m³ or even larger, such as 5 m³. The enclosed space is thus, for example, between 0.25 and 5 m³, advantageously in the range between 0.8 and 1.5 m³. The enclosed volume also does not always have to be enclosed by a cube, but may also be enclosed by a cuboid. According to further embodiments, a shape deviating from a cuboid may also be created.

FIG. 1 shows a base frame 10 having with the dimensions explained above, for example. The base frame 10 has a cubic shape and thus forms six outer surfaces. The six outer surfaces are formed by 12 profiles extending along the edges of the cube. The 12 profiles are divided into four vertical profiles 12v, four horizontal profiles 12h and four profiles 12d oriented in the depth direction. For example, the profiles may be aluminum profiles which are screwed together at the respective corners of the cube (aluminum frame on profile basis). In the embodiment illustrated here, corners of 90° are formed so that the vertical profiles 12v, the horizontal profiles 12h and the profiles 12d extending in the depth direction each have an identical length. In this embodiment, only the vertical profiles 12v differ with respect to their length from the other profiles 12h and 12d which are approximately of equal length. Approximately of equal length since there is a difference in profile length at the corners due to the connection geometry in order to be able to form a rectangular side wall.

FIG. 3 illustrates the shielding panels 22, 24 and 26 which can be screwed onto the profiles. For example, the elements 22 are square and are intended for the square side walls, while the elements 24 and 26 are each rectangular and are intended for the front side or top and bottom side. According to embodiments, all shielding plates 22, 24 and 26 may differ from each other, e.g., by their geometry or folding geometry. The folding is provided with the reference numerals 22k and 24k. For example, one of the elements, here element 22, has four folded sides 22k (all folded in one direction), while a further element, here element 24, comprises two folded sides 24k (in one direction, namely the opposite one), wherein the element 26 has no folded side. Thus, when viewed on all six elements 22, 24 and 26, 12foldings are provided for the 12 edges of the cube. Of course, these foldings may also be configured differently. For example, the elements 24 and 26 may be configured identically with one folding each. The purpose of the folding is to ensure overlap, so that the shielding plates do not abut against each other and are instead overlapped, thereby preventing radiation from passing through the abuttment area.

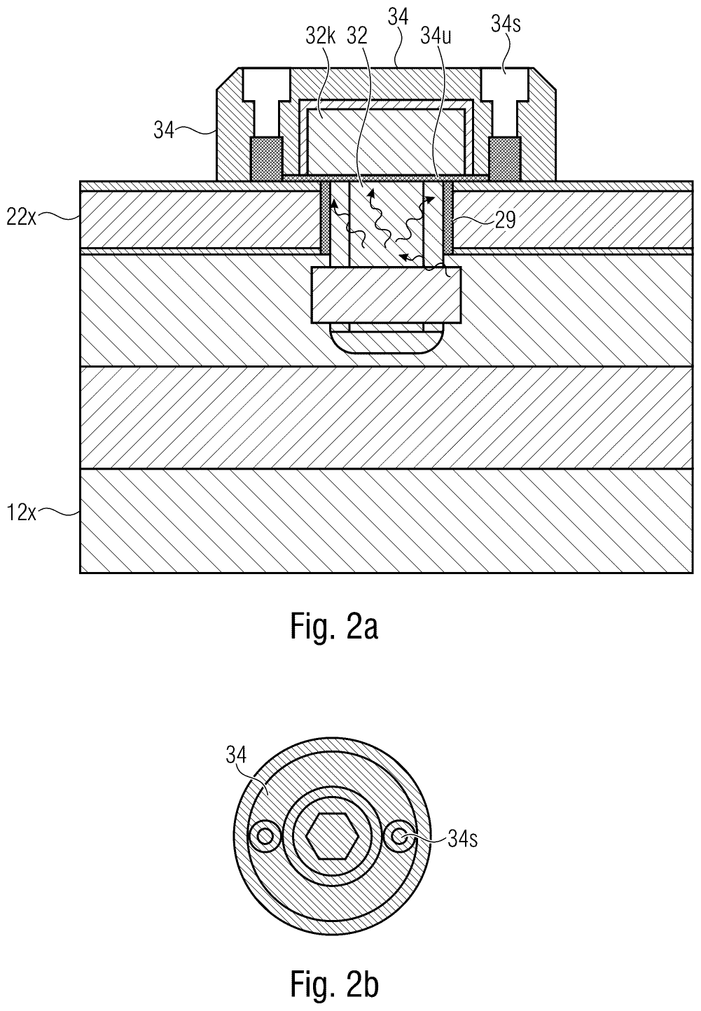

According to embodiments, the shielding panels 22, 24 and 26 may be screwed to the frame precisely in the area of the folding 22k, 24k and 26k. For this purpose, through-holes are provided in this area. The through-holes are marked with the reference numeral 29. As can be clearly seen here, the through-hole extends once around the folded area 22k and 24k and also through the flat area of the respective adjacent shielding plate 24 and 26 and 22. In this area, screws may be provided for fastening the shielding plates 22, 24, 26 to the base frame. The screws, and connecting elements in general, are explained by way of example in FIGS. 2a and 2b. At this point, it is to be noted at the outset that other screw connections may also be provided for the modular construction kit system and other fastening elements, e.g. plug-in rivets. According to advantageous embodiments, the screws or screw connections or connecting elements in general have shielding properties.

FIG. 2a shows a sectional illustration through the profile 12x, the shielding plate 22x and the screw 32 together with the shielding collar 34. FIG. 2b shows a top view, in particular of the screw 32 and the shielding collar 34.

FIG. 2a shows a screw 32 which is screwed into a nut 34. The nut 34 is a nut of the profile 12x inserted into the profile channel (cf. with the previously mentioned profiles 12v, 12h and 12d). The nut 34 is inserted into a groove of the profile 12x, so that the screw 32 can be fastened somewhat to the profile. In this embodiment, the shielding plate 22x (cf. with the shielding plates 22, 24 and 26) is screwed on. In order to prevent radiation, shown here by means of the arrows, from escaping through the through-hole, a shielding collar 34 is provided in the area of the screw head 32k. This shielding collar 34 is also illustrated in FIG. 2b, namely in the top view. For example, the shielding collar 34 may be plugged onto the screw head 32k. Alternatively, it would also be conceivable that the shielding collar 34 is screwed on. This situation is illustrated here. The shielding collar 34 is placed onto the screw head 32k from above and is fastened by means of screws 34s to a washer 34u which is inserted under the screw head 32k. Alternatively, the shielding collar 34 may of course also be realized as a type of washer. After the mode of operation has now been explained, the effect and method of production of the shielding collar 34 will be discussed in the following. The shielding collar is mounted over the protruding screw head of a screw guided through the housing by being locked over the through-screw to a screw-on device mounted as a washer or on the screw head of the through-screw. For this purpose, safety screws are used which prevent simple unscrewing and thus comply with the safety regulations. The shielding collar is configured in its shielding thickness for the respective protection category (A, B, C) and is identified in color. The shielding collar may be produced from lead using the casting method or from special plastic using the injection molding method. The washer thus represents a supplement to the actual connecting screw which has screw-on surfaces which in turn serve for screwing on the radiation protection cover. In addition to the shielding itself, tightening with safety screws is also made possible which in turn is an important property for such housings.

Optional aspects with regard to the radiation protection housing and in particular with regard to the shielding panels 22, 24 and 26 will be explained in the following. For example, the housings 10 have a rectangular structure consisting of 6 end faces. The panels 22, 24, 26 are offered in a fixed size grid and have three types of design which, taken together, create the overlapping regions for the radiation shielding. The base material for the surface shielding represents a lead element of the corresponding thickness (A, B, C) laminated on both sides with a metal sheet. This is shaped differently for the three different panel categories.
i. Type 1: End faces—the end faces of the panel 22 are covered by a sheet metal-lead-sheet metal panel pressed on four sides. The corners of the housing are sufficiently covered by the pressing method without a radiation leakage occurring.
ii. Type 2: Side faces 1: The side faces of the panel 24 are configured so as to be smooth, without an edge.
iii. Type 3: Side face 2: Two further side faces of the panel 26 are configured with one edge each on the short sides.

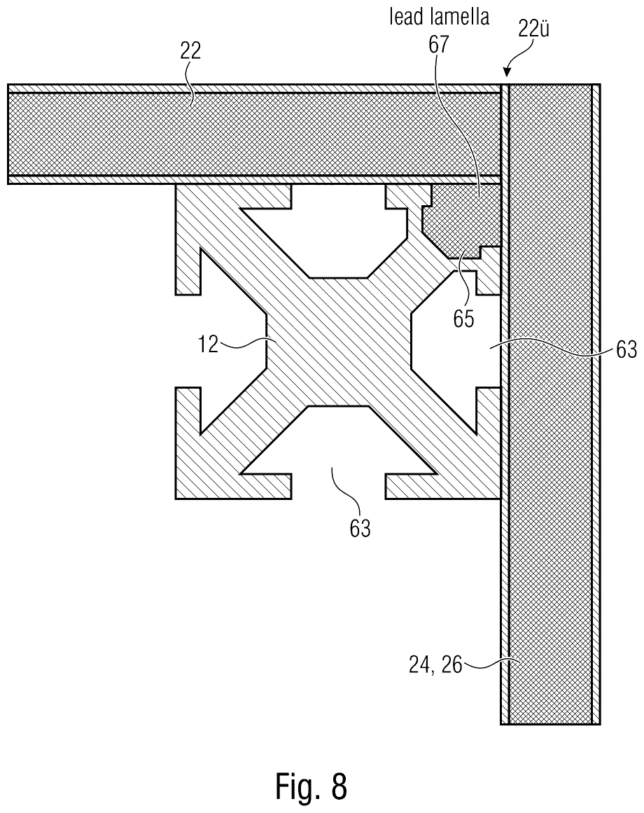

An alternative to the overlap will be explained in the following with reference to FIG. 8. FIG. 8 shows a profile/square profile/aluminum profile for the base frame in the sectional illustration. As can be seen, the profile 12 may comprise a plurality of recesses 63, here four recesses 63, on the respective side faces. The recesses 63 serve for receiving a nut/groove nut into which the connecting means/connecting screws 32 explained above may be screwed. Furthermore, additional recesses 65 may also be provided, e.g., on the edges of the profile 12. According to an embodiment, it would be conceivable that optional radiation protection elements 67 are inserted into one of the profiles 63 or 65, here into the profile 65, or also into a plurality of profiles. For example, the element 67 may be an insert made of lead along an end face of the profile 12. The element, or the lamella, 67 may also have a profile shape. Due to the lamella 67, radiation leakage via the edge abutment of the panels 22, 24 and 26 can also be prevented without folding. According to embodiments, the panels 22, 24 and 26 have an overlap 22u in the area of the edge. This serves for additional radiation protection.

According to embodiments, attachments may be provided in the construction kit. These are, for example, cable bushings, doors and flaps. Cable bushings, doors and flaps are also offered as standard assemblies which are screwed directly to the shielding plates. In this case, the necessary openings and screw-on points on the panels 22x are cut in advance, for example. For example, the attachments are screwed through from the inside to the outside (cf. screw 32) and are thereby sealed by means of the shielding collars 34.

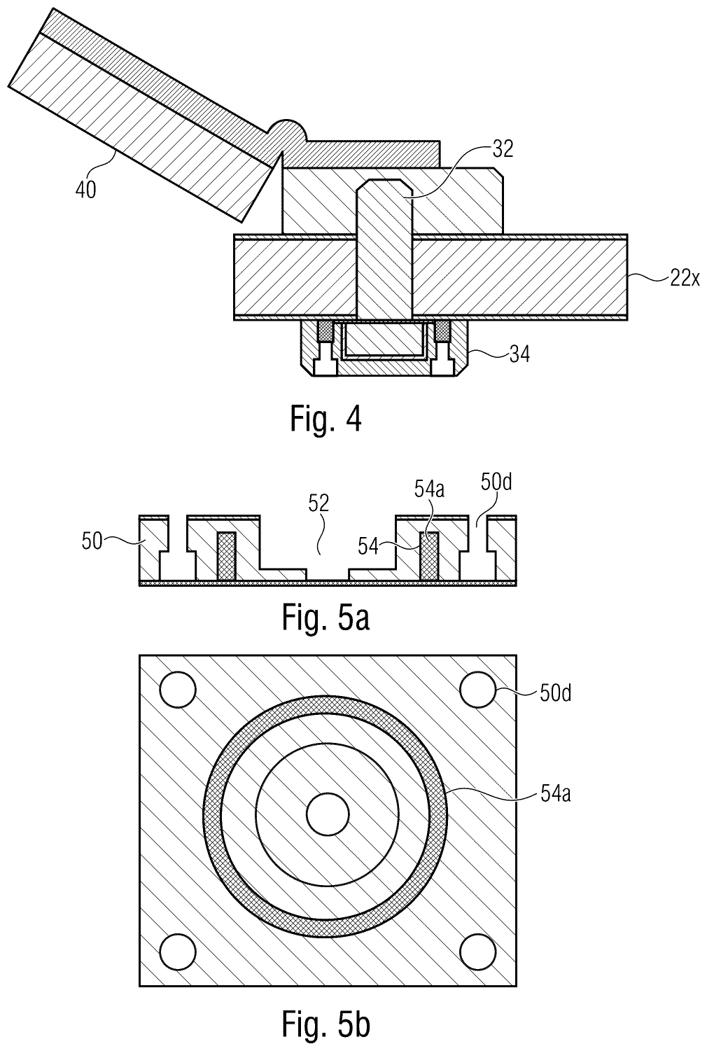

FIG. 4 shows the fastening of a flap 40 to a shielding element 22x using a screw 32. The screw 32 is screwed through the shielding profile 22x from the inside and in this case engages with a thread of a component of the flap 40. In this embodiment, the screw 32 also comprises a shielding collar 34. For example, the cover 40 is located on the inside, while the cover is screwed in from the inside by means of the screw 32. According to further embodiments, this may be exactly the reverse, for example, if the cover 40 is to open to the outside. According to embodiments, the cover 40 itself comprises a shielding material, in particular if the latter is to cover a passage, such as a cable bushing or an opening.

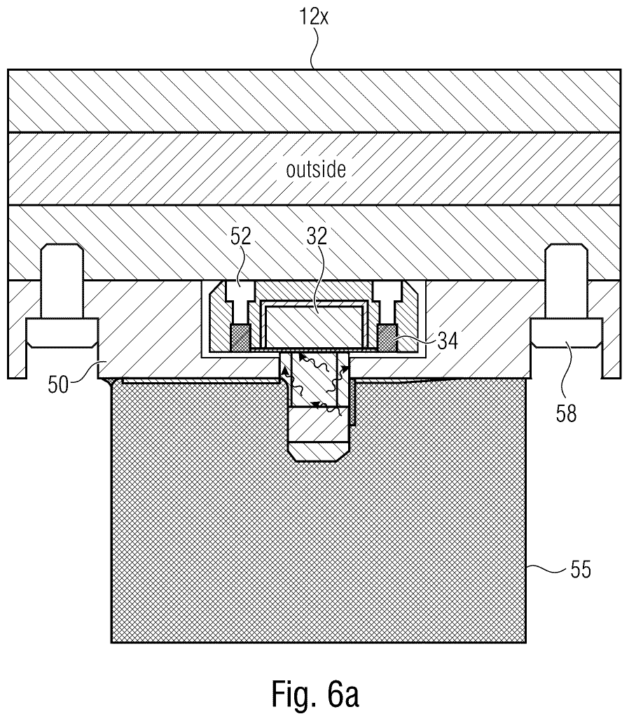

A further attachment is shown in FIGS. 5a and 5b, namely a mounting point 50. FIG. 5a shows a sectional illustration of the mounting point 50, while FIG. 5b shows a top view of the mounting point. The mounting point serves for mounting internal components, such as X-ray components and positioning devices, or also for connecting the radiation protection housing to or with an external component.

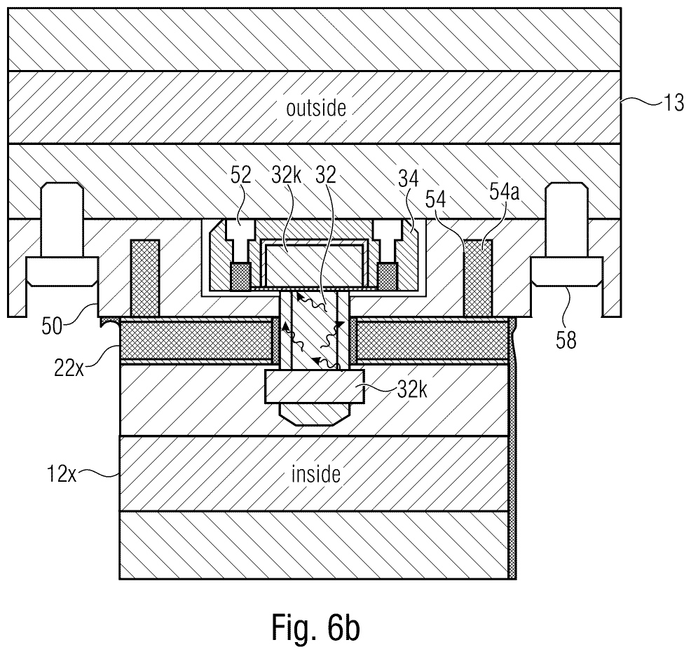

For example, the element may be coupled to the profile 12x, as illustrated in FIGS. 6a and 6b. For example, the mounting point 50 includes four fastening screws for fastening the mounting point 50 to the profile 10x. For example, the screws 58 illustrated in FIG. 6 may be used for this purpose. Furthermore, the mounting point 50 includes a recess 52 for the screw 32 with or without the shielding collar 34. The screw 32 protrudes from a first side through the mounting point 50, while the screws 58 protrude from a second (opposite) side through the mounting point 50. Furthermore, the mounting point may also comprise recesses 54 for shielding elements 54a, which are less relevant for the use in the interior of the radiation protection housing (FIG. 6a) and more relevant on the outside (FIG. 6b).

As illustrated in FIG. 6a, an element 55 may be mounted to the frame 12x, e.g. on the inside, by means of the mounting point 50. For example, the element 55 is a component of the X-ray system, such as e.g. a radiation receiver connected to the screw 32. Instead of the screw, a nut may also be inserted into the recess 52, so that the component to be fastened can also be fastened directly with a screw. The recess 52 may also have the shape of a nut (hexagon), or a screw head, in order to facilitate the process of being screwed-in by torque support. Instead, the element 50 may also comprise a thread.

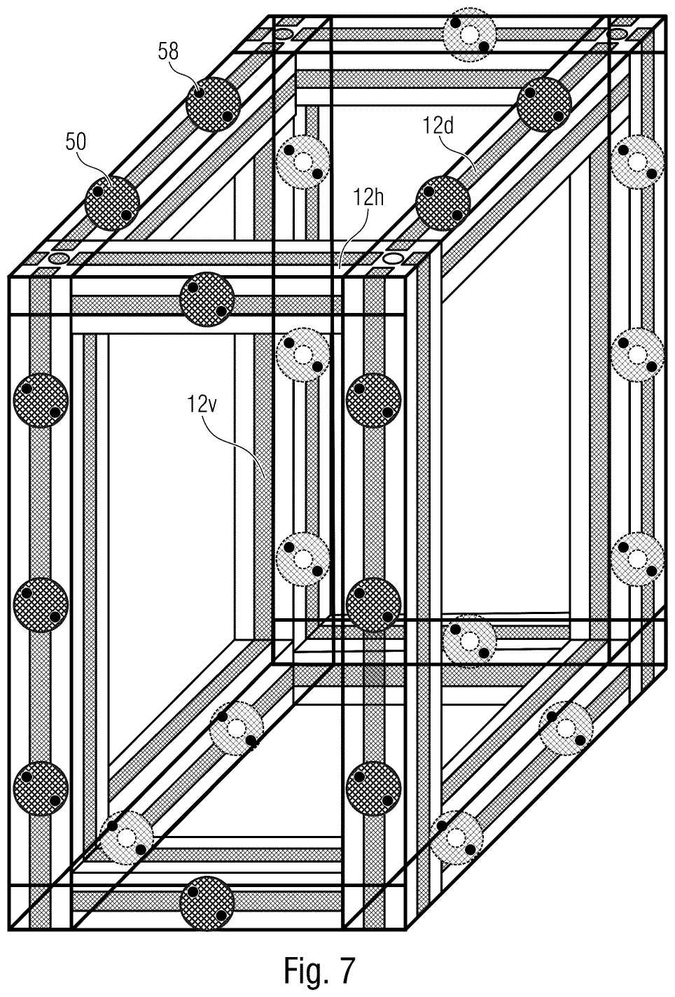

FIG. 7 illustrates the fastening of the mounting points 57 to the elements 12v, 12h and 12d by means of the screws 58. In this respect, the screw-on plate 50 may form a mounting point 57 on the inside.

In addition to the mounting points for larger elements, smaller elements, such as, for example, safety elements, such as door contact switches and lighting systems, may be fastened via preconfigured adapters as further attachments.

According to embodiments, the mounting point 50 serves not only for mounting elements on the inside of the housing 10, but also on the outside. This example will be explained in the following with reference to FIG. 6b.

FIG. 6b illustrates the use of the element 50 on the outside. FIG. 6b shows a profile 12x on which a shielding plate 22x is mounted by means of the connecting means 32 and 32k. The connecting means 32 fasten not only the shielding plate 22x on the profile 12x, but also the screw-on plate 50.

In this embodiment, the element 50 is not mounted from the inside by means of the screws 58, but fastens the entire system via the outside to a further element, such as a further profile 13. By means of this, the radiation protection housing may then be screwed onto an external element (further profile 13) or an external element may be screwed onto the radiation protection housing.

In order to prevent radiation leakage, further radiation absorbers 54a are provided in the recesses 54. These elements 54a may also be referred to as radiation protection housings. For example, radiation absorbers 54a and recesses 54 may be arranged concentrically around the screw 32. The screw 32 with screw head 32k and shielding collar 34 is arranged in the recess 52 from the other side.

In summary, it is thus to be noted that both a mounting point for fastening components on the inside and attachments on the outside may be present in the modular construction kit system.

The basic shape of the modular construction kit for forming a radiation protection housing thus forms the radiation protection housing itself based on a profile frame in combination with shielding plates which are connected to the base housing by means of releasable fastening elements, e.g. screws. Furthermore, the modular construction kit may also comprise further attachments, e.g. covers, cable bushings or flaps. Additionally or alternatively, the modular radiation protection construction kit may also comprise mounting points for fastening X-ray components in the interior or further components in the outer element. Advantageously, all fastening components are connected to the base frame. According to embodiments, attachment components may also be connected to the shielding panels.

According to embodiments, all penetrations of the shielding panels, e.g. in the case of screw holes, may be equipped with additional radiation protection means, e.g. shielding collars. Special radiation protection housings may also be provided.

All shielding elements, e.g. the shielding panels, may be present in a construction kit for different shielding classes. That is, a plurality of different shielding panels which differ, for example, with respect to their shielding characteristics, in particular their thickness, is provided for one size. The shielding collars may also have different dimensions. Advantageously, a shielding material or also a shielding sandwich structure is used in order to avoid damage to the shielding material.

At this point, it is to be noted that the shielding panels may also vary in some other way, namely with respect to their geometric dimensions (length, width), so that differently sized radiation protection devices can be created with the same construction kit. According to the size of the shielding panels, the size of the profiles also varies (cf. 12v, 12h and 12d). Thus, it is advantageously possible to create differently sized (cubic) radiation protection housings.

A further embodiment provides a radiation protection housing, in particular a cubic radiation protection housing, for example for safety control, industrial X-ray systems or medical X-ray systems with a radiation source and/or X-ray detector arranged in the radiation protection housing. The radiation protection housing or the radiation protection housing may be configured for X-ray radiation or also other radiations.

Even if a cubic radiation protection housing was mentioned in the above embodiments, it would also be conceivable that, instead of the cubic housing with six side faces, a radiation protection housing with more than six, such as eight or ten side faces, may be created.

The above embodiments are only illustrative, while the scope of protection of the invention is defined by the following claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCE NUMERALS

Radiation protection housing (10)
Base frame (12v, 12h, 12d)
Shielding panels (22, 24, 26)
Fastening devices (32, 32k)
Shielding collar (34)
Screw-on plate (50)
Folded edge (22k, 24k, 26k)
Attachment (40)

1. Radiation protection housing comprising:
a base frame;
a plurality of shielding panels fastened to the base frame by means of releasable fastening devices or by means of releasable fastening devices with a radiation protection function;
wherein the base frame, the shielding panels and the releasable fastening devices are part of a modular construction kit system;
wherein the plurality of shielding panels are shielding panels of different geometries, wherein the first geometry comprises 4 folded edges, the second geometry comprises 2 folded edges, and the third geometry comprises no folded edge.

2. Radiation protection housing according to claim 1, wherein the releasable fastening devices or the releasable fastening devices with the radiation protection function comprise a shielding collar, or wherein the modular construction kit comprises a shielding collar for the releasable fastening devices or the releasable fastening devices with the radiation protection function.

3. Radiation protection housing according to claim 2, wherein the shielding collar comprises the shape of a washer or the shape of a cover for a screw head of the releasable fastening devices or the releasable fastening devices with the radiation protection function; and/or
wherein the shielding collar comprises the shape of a washer for the releasable fastening devices or the releasable fastening devices with the radiation protection function in the form of a connecting screw which comprises screw-on surfaces serving for screwing on the radiation protection cover; and/or
wherein the shielding collar comprises a shielding material.

4. Radiation protection housing according to claim 1, wherein the plurality of shielding panels and/or shielding collars and/or further parts of the modular construction kit are configured to shield and/or absorb X-ray radiation, in particular X-ray radiation with 60 kV, 130 kV or 160 kV.

5. Radiation protection housing according to claim 1, wherein the shielding panels comprise a sandwich structure with a central lead element and metal sheets enveloping the central lead element.

6. Radiation protection housing according to claim 1, wherein the plurality of shielding panels of the modular construction kit system comprise different sizes.

7. Radiation protection housing according to claim 1, wherein the radiation protection housing comprises as part of the modular construction kit a screw-on plate on the outside.

8. Radiation protection housing according to claim 1, wherein the radiation protection housing comprises as part of the modular construction kit one or more attachments, in particular in the form of cable bushings, doors or flaps.

9. Radiation protection housing according to claim 8, wherein one of the plurality of shielding panels comprises an opening for one of the attachments; or
wherein one of the plurality of shielding panels comprises an opening for one of the attachments, so that the attachment can be mounted into the shielding panel from the inside of the radiation protection housing.

10. Radiation protection housing according to claim 1, wherein the base frame comprises one or more mounting points for mounting; and/or
wherein the radiation protection housing comprises a screw-on plate for mounting an element in the radiation protection housing.

11. Radiation protection housing according to claim 1, wherein the modular construction kit comprises different shielding panels and/or different shielding collars and/or different further parts of the modular construction kit system, which can be used alternatively and differ with respect to their shielding properties and/or absorption characteristics.

12. Radiation protection housing according to claim 9, wherein the modular construction kit comprises shielding panels and/or shielding collars and/or further parts of the modular construction kit system with a fixed categorization to a radiation protection class; or
wherein the modular construction kit comprises shielding panels and/or shielding collars and/or further parts of the modular construction kit system with a fixed categorization to a radiation protection class, wherein the shielding panels and/or the shielding collars and/or the further parts comprise a color identification assigned to the fixed categorization.

13. Radiation protection housing according to claim 1, wherein the base frame comprises a profile or square profile or aluminum profile.

14. Radiation protection housing according to claim 13, comprising a radiation protection element, in particular a radiation protection element arranged along a side face of the profile.

15. Radiation protection housing according to claim 1, wherein the radiation protection housing comprises a cubic shape and/or the shielding panels are rectangular elements; and/or
wherein the volume of the radiation protection housing is dimensioned in the range between 0.5 to 5 m³ or in the range of 0.8 to 1.5 m³, in particular in the range of 1×1×1 m³.

16. Radiation protection housing comprising:
a base frame;
a plurality of shielding panels fastened to the base frame by means of releasable fastening devices or by means of releasable fastening devices with a radiation protection function;
wherein the base frame, the shielding panels and the releasable fastening devices are part of a modular construction kit system;
wherein the plurality of shielding panels are shielding panels of different geometries, wherein the geometries differ by the number of folded edges.
